(19) United States
(12) Patent Application Publication
(10) Pub. No.: US 2018/0361438 A1
(43) Pub. Date: Dec. 20, 2018

(54) HVAC Flushing tool

(71) Applicants: John F. Smeltzly, Reynoldsburg, DC (US); Diana L. Platt, Reynoldsburg, OH (US)

(72) Inventors: John F. Smeltzly, Reynoldsburg, DC (US); Diana L. Platt, Reynoldsburg, OH (US)

(21) Appl. No.: 15/627,439

(22) Filed: Jun. 19, 2017

(51) Int. Cl. B08B 9/032

(52) U.S. Cl. CPC B08B 9/0321

(57) ABSTRACT

The current invention is a flushing tool that allows the technician to flush open line sets without holding on a fitting. The flushing tool has a rounded circular base. Extending from the front have the base are a series of hose mounts which are connected to the base largest unit to the smallest. These tube mounts are circular and extend out with from the base. The back of the base has a recessed treaded socket to which a pipe or service flush hose or injection valve or other such connection means can be attached. The connection means connects a flush distribution system like a pressurized can or some type of pump which contains the flush which is a formulation is powerful enough to flush away sludge, carbon residue, oils, acids, water and other particulate from the HVAC system.

### CROSS-REFERENCES TO RELATED APPLICATIONS (IF ANY)

None.

### BACKGROUND

### 1. Field of the Invention

This invention relates to HVAC tools and particularly ones that are used in the flushing of HVAC tubes and tubing.

### 2. Description of Prior Art

Refrigeration and air conditioning systems can suffer failures which result in contamination. The most common such failure is a compressor burnout. The will cause the refrigeration system to become contaminated with massive quantities of unwanted particulate, sludge, acids, carbon residues and possibly moisture. These contaminants must be removed before the system can be used.

Flushes, where are unique solvents, have been engineered for flushing refrigeration and air conditioning systems to wash out sludge, carbon residue, oils, acids, water and other particulate.

However with different size tubing used in different system it can make it difficult to have a unique delivery system that requires more than one size or that fit properly for all the tubing sizes.

There is still room for improvement in the art.

### SUMMARY OF THE INVENTION

The current invention is a HVAC Flushing Tool that allows a user to flush open lines sets of multiple dimensions and set sizes using a single tool. HVAC (heating, ventilating, and air conditioning; also heating, ventilation, and air conditioning) is the technology of indoor and vehicular environmental comfort. Its goal is to provide thermal comfort and acceptable indoor air quality. HVAC system design is a subdiscipline of mechanical engineering, based on the principles of thermodynamics, fluid mechanics, and heat transfer.

This is a new generation of flushing tools that allows the technician to flush open line sets without holding on a fitting. It is used to flush line sets sizes.

The flushing tool has a rounded circular base. Extending from the front have the base are a series of hose mounts which are connected to the base largest unit to the smallest centered on the center of the base. These tubing mounts are circular and extend out with from the base. The mounts fit such hose sizes like 1⅛″, ⅞″, ¾″, ⅝″ and ⅜″.

The back of the base has a centered recessed treaded socket to which a pipe or service flush hose or injection valve or other such connection means can be attached. The connection means connects a flush distribution system like a pressurerise can or some type of pump which contains the flush. The flush is a formulation is powerful enough to flush away sludge, carbon residue, oils, acids, water and other particulate from the HVAC system.

The flushing tool has a flushing tube that runs from the socket to the tip at the front of the tool. This tube serves as a conduit for the flush to flush out the line.

This is an improvement over existing art.

### BRIEF DESCRIPTION OF THE DRAWINGS

Without restricting the full scope of this invention, the preferred form of this invention is illustrated in the following drawings:

FIG. 1 shows the flushing tool;

FIG. 2 shows the front view of the flushing tool;

FIG. 3 shows the back view of the flushing tool;

FIG. 4 shows a cutaway view of the tool;

FIG. 5 shows the tool and pipe units; and

FIG. 6 shows the tool being used.

### DESCRIPTION OF THE PREFERRED EMBODIMENT

There are a number of significant design features and improvements incorporated within the invention.

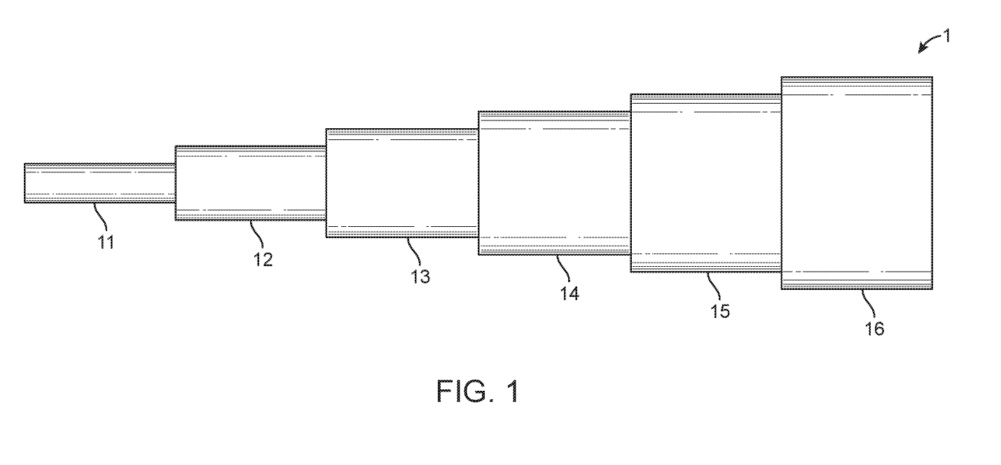

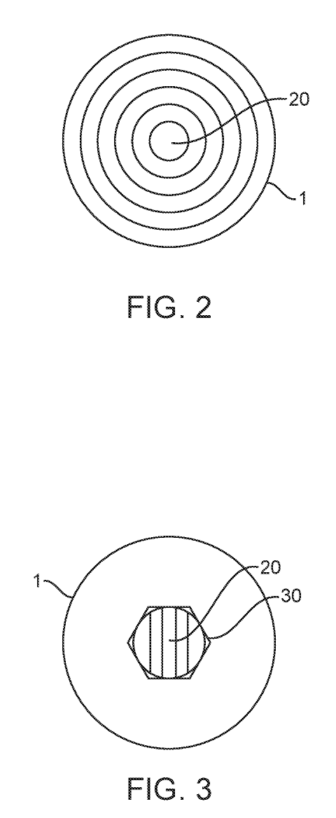

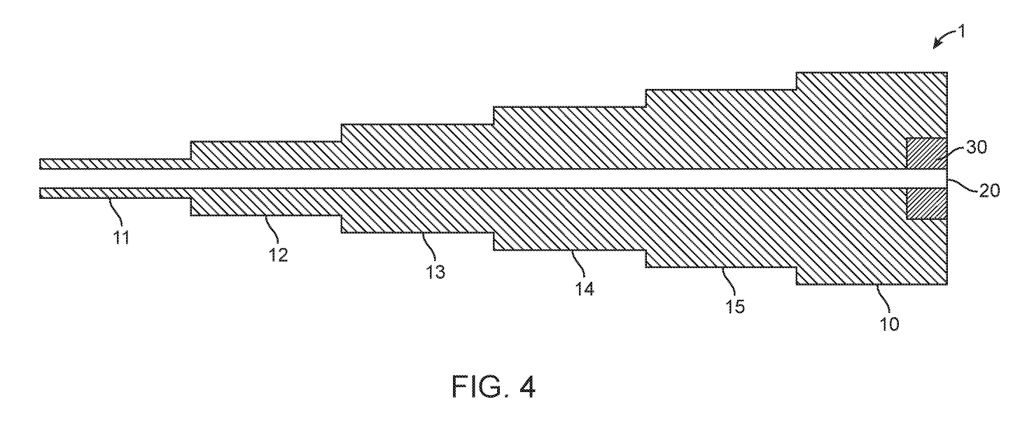

As shown in FIGS. 1 through 6, the current invention is a HVAC (heating, ventilating, and air conditioning; also heating, ventilation, and air conditioning) Flushing Tool 1 that allows a user to flush open tubing lines sets of multiple dimensions and set sizes using a single tool.

The current invention is a new set of flushing tools that allows the technician to flush open line sets without holding on a fitting. It can be used to flush different tubing line sets sizes.

The flushing tool 1 has a rounded circular base 16 with a flat front and back. Extending from the front in a telescoping fashion from the base 16 are a series of hose mounts (15, 14, 13, 12 and 11) which are connected to the base 16 in order of the largest unit to the smallest. These hose mounts (15, 14, 13, 12 and 11) are circular and extend out with from the base 16 and are centered on the base 16. The mounts fit such hose sizes like 1⅛″, ⅞″, ¾″, ⅝″ and ⅜″.

The back of the base 16 has a recessed treaded socket 30 to which a pipe 70 or service flush hose or injection valve or other such connection means can be attached. The connection means connects a flush distribution system like a pressurize can 100 or some type of pump which contains the flush which is a formulation is powerful enough to flush away sludge, carbon residue, oils, acids, water and other particulate from the HVAC system. The flush distribution system will have enough pressure to drive the flush through the HVAC system cleaning it.

The flushing tool has a flushing tube 20 that runs from the socket to the tip at the front of the tool 1 in its center from front to back. The flush tube 20 has an opening through the center of the smallest tube mount 11. This tube 20 serves as a conduit for the flush to flush out the line.

In the preferred embodiment, the flush tool 1 is made of a light weigh solid metal such as aluminum. Other materials or configurations such as the tool 1 not being solid but a molded hollow design with an enclosed flushing tube 20 or made out of another material such as steel, plastic or harden rubber.

Operation

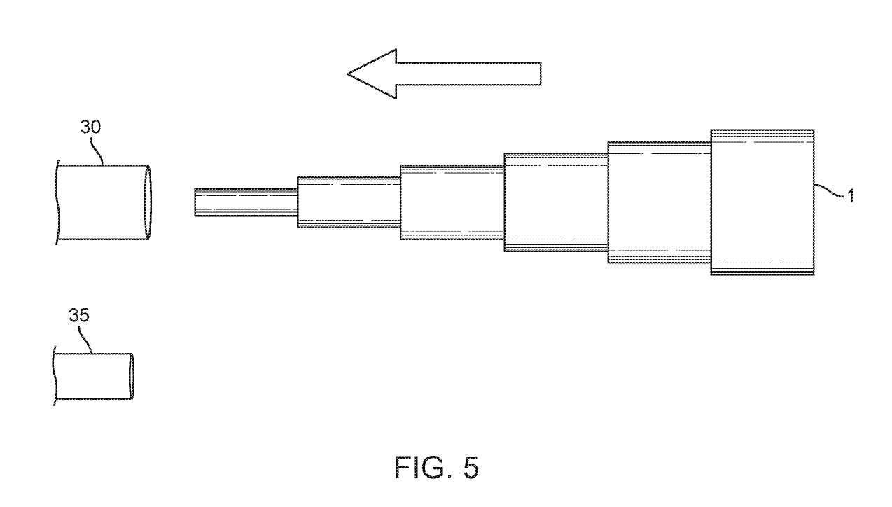

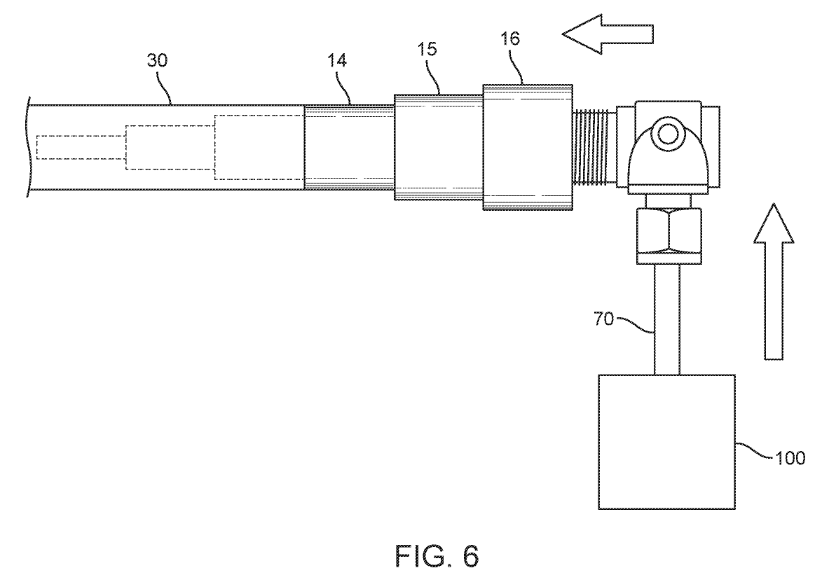

As shown in FIGS. 5 and 6, the user takes the flushing tool 1 and connect it to the flush distribution system like a pressurized can 100. There is a connection means 70 that connect the distribution system to the flushing device 1. The flushing tool 1 is then inserted into the tube 30 up to the edge of the size that matches the tube 30. The flush then runs through the distribution system through the flushing tube 20 into the tube 30 to flush the HVAC system.

Advantages

The current invention's control at the injection point makes flushing easy and more practical for the technician.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A device comprising:
a flushing tool with a rounded circular base with a flat front and back with a plurality of mounts extending from the front in a telescoping fashion from the base which are circular with a flush tube that runs from the front to the back of the base.

2. The device according to claim 1 comprising:
Where the mounts are centered on the base.

3. The device according to claim 1 comprising:
Where the mounts fit one or more hose size.

4. The device according to claim 3 comprising:
Where the hose sizes are one of more of the sizes of 1⅛″, ⅞″, ¾″, ⅝″ and ⅜″.

5. The device according to claim 1 comprising:
Where the back of the base has a recessed socket.

6. The device according to claim 5 comprising:
Where the socket is treaded.

7. The device according to claim 1 comprising:
Where a connection means is attached and said connection means connects to a flush distribution system.

8. The device according to claim 7 comprising:
Where the flush distribution system distributions a flush.

9. The device according to claim 8 comprising:
Where the flush distribution system is a pressurize can.

10. The device according to claim 8 comprising:
Where the flush is a cleaning formulation.

11. The device according to claim 8 comprising:
Where the base is formed of a solid piece.

12. A device comprising:
a flushing tool with a rounded circular base with a flat front and back with a plurality of mounts extending from the front in a telescoping fashion from the base which are circular with a flush tube that runs from the front to the back of the base, where the mounts are centered on the base, where the mounts fit one or more hose size and where the back of the base has a recessed socket.

13. The device according to claim 12 comprising:
Where the hose sizes are one of more of the sizes of 1⅛″, ⅞″, ¾″, ⅝″ and ⅜″.

14. The device according to claim 12 comprising:
Where the socket is treaded.

15. The device according to claim 12 comprising:
Where a connection means is attached and said connection means connects to a flush distribution system where the flush distribution system distributions a flush.

16. The device according to claim 12 comprising:
Where the flush distribution system is a pressurize can.

17. The device according to claim 13 comprising:
Where the flush is a cleaning formulation.

18. The device according to claim 14 comprising:
Where the base is formed of a solid piece.

19. A process to flush HVAC tubing using the device in claim 12.
